(19) United States
(12) Patent Application Publication
(10) Pub. No.: US 2022/0147960 A1
(43) Pub. Date: May 12, 2022

(54) METHOD FOR MANAGING CONTENT SHARING PLATFORM COMBINED WITH E-COMMERCE CAPABILITIES AND APPARATUS FOR PERFORMING THE SAME

(71) Applicant: JAAEM INC., Seongnam-si (KR)

(72) Inventor: Jung Jin LEE, Seoul (KR)

(73) Assignee: JAAEM INC., Seongnam-si (KR)

(21) Appl. No.: 17/110,578

(22) Filed: Dec. 3, 2020

(30) Foreign Application Priority Data
Nov. 12, 2020 (KR) 10-2020-0151171

(51) Int. Cl. G06Q 20/12; G06Q 50/00; G06Q 30/06; G06Q 20/38; G06Q 50/18; H04L 29/08

(52) U.S. Cl. CPC G06Q 20/1235; G06Q 50/01; G06Q 30/0633; G06Q 30/0631; G06Q 50/184; G06Q 30/0639; H04L 67/10; G06Q 20/384

(57) ABSTRACT

Disclosed herein are a method of managing a content sharing platform combined with e-commerce capabilities and an apparatus for performing the same. The method of managing a content sharing platform combined with e-commerce capabilities includes: providing one or more pieces of content to a user through a content sharing platform; when the user purchases a product through the content sharing platform, determining one or more targets and a ratio, to whom and at which profits from the sale of the product will be distributed, based on a history in which the user viewed the content through the content sharing platform; and distributing the profits to the determined targets based on the determined ratio.

### CROSS-REFERENCE TO RELATED APPLICATION

This application claims the benefit of Korean Patent Application No. 10-2020-0151171 filed on Nov. 12, 2020, which is hereby incorporated by reference herein in its entirety.

### BACKGROUND

### 1. Technical Field

The embodiments disclosed herein relate to a method of managing a content sharing platform combined with e-commerce capabilities and an apparatus for performing the same.

### 2. Description of the Related Art

Today, the rate of use of platforms for sharing content, such as YouTube, is increasing. A large quantity of content promoting specific products is being produced. Accordingly, there ire many cases in which personally produced content influences other people's decisions to purchase products.

Meanwhile, according to the currently used systems, a platform that provides content and a platform that sells products are separated from each other, and thus inconvenience arises in that after viewing content, a user has to access another platform to purchase a product promoted in the content.

Furthermore, even when content has influenced a decision to purchase a product, any profit is not distributed to a person who created the content, and thus there is a limitation in that the creator of content is not sufficiently motivated to promote a product.

Meanwhile, the above-described background technology corresponds to technical information that has been possessed by the present inventor in order to contrive the present invention or that has been acquired in the process of contriving the present invention, and can not necessarily be regarded as well-known technology that had been known to the public prior to the filing of the present invention.

### SUMMARY

The embodiments disclosed herein are intended to provide a method of managing a platform that performs both the provision of content and the sales of products on a single platform and distributes a portion of profits from the sale of a product to the creator of content having distributed to the sale of the product and an apparatus for performing the same.

As a technical solution for accomplishing at least one of the above objects, according to one embodiment, there is provided a method of managing a content sharing platform combined with e-commerce capabilities, the method including: providing one or more pieces of content to a user through a content sharing platform; when the user purchases a product through the content sharing platform, determining the targets and ratio, to whom and at which profits from the sale of the product will be distributed, based on a history in which the user viewed the content through the content sharing platform; and distributing the profits to the determined targets based on the determined ratio.

According to another embodiment, there is provided a non-transitory computer-readable storage medium having stored thereon a computer program that, when executed by a processor, causes the processor to execute a method of managing a content sharing platform combined with e-commerce capabilities, wherein the method includes: providing one or more pieces of content to a user through a content sharing platform; when the user purchases a product through the content sharing platform, determining one or more targets and a ratio, to whom and at which profits from the sale of the product will be distributed, based on a history in which the user viewed the content through the content sharing platform; and distributing the profits to the determined targets based on the determined ratio.

According to still another embodiment, there is provided a computer program that is executed by a computing apparatus and stored in a storage medium to perform a method of managing a content sharing platform combined with e-commerce capabilities, wherein the method includes: providing one or more pieces of content to a uses through a content sharing platform; when the user purchases a product through the content sharing platform, determining one or more targets and a ratio, to whom and at which profits from the sale of the product will be distributed, based on a history in which the user viewed the content through the content sharing platform; and distributing the profits to the determined targets based on the determined ratio.

According to still another embodiment, there is provided a computing apparatus for managing a content sharing platform combined with e-commerce capabilities, the computing apparatus including: a communication interface configured to communicate with a terminal of a user who uses a content sharing platform; storage configured to store information for the sales of a plurality of products, content corresponding to each of the plurality of products, and a program for managing the content sharing platform; and a controller including at least one processor; wherein the controller executes the program, thereby providing one or more pieces of content to the user through the content sharing platform, and, when the user purchases a product through the content sharing platform, determining the targets and ratio, to whom and at which profits from a sale of the product will be distributed, based on a history in which the user viewed the content through the content sharing platform, and distributing the profits to the determined targets based on the determined ratio.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a drawing showing a system for providing a content sharing platform combined with e-commerce capabilities according to an embodiment;

FIG. 2 is a diagram illustrating the configuration of an apparatus for providing a content sharing platform combined with e-commerce capabilities according to an embodiment;

FIG. 3 is a diagram showing UI screens that are provided to a user through a content sharing platform combined with e-commerce capabilities according to an embodiment; and

FIGS. 4 to 6 are flowcharts illustrating methods of managing a content sharing platform combined with e-commerce capabilities according to embodiments.

### DETAILED DESCRIPTION

Various embodiments will be described in detail below with reference to the accompanying drawings. The following embodiments may be modified to and practiced in various different forms. In order to more clearly illustrate the features of the embodiments, detailed descriptions of items that are well known to those having ordinary skill in the art to the following embodiments pertain will be omitted. In the drawings, portions unrelated to the following description will be omitted. Throughout the specification, like reference symbols will be assigned to like portions. Throughout the specification, when one component is described as being “connected” to another component, this includes not only a case where they are “directly connected” to each other but also a case where they are “connected to each other with a third component disposed therebetween.” Furthermore, when a component is described as “including” another component, this does not mean that the former component excludes another component but means that the former component may further include another component, unless explicitly described to the contrary.

Embodiments will be described in detail below with reference to the accompanying drawings.

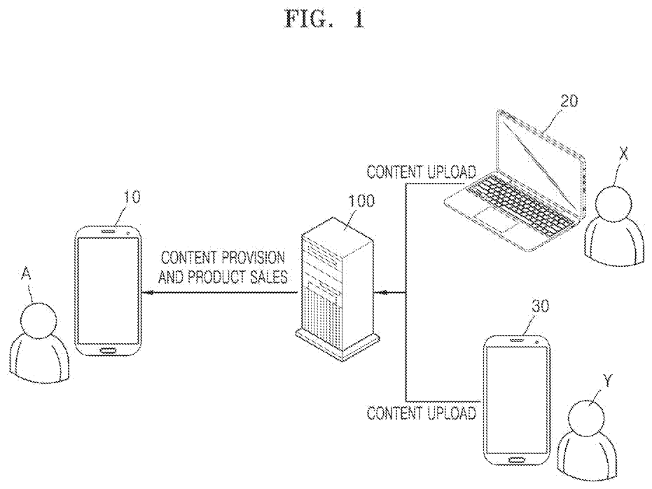

FIG. 1 is a drawing showing a system for providing a content sharing platform combined with e-commerce capabilities according to an embodiment. In the system shown in FIG. 1, a server 100 provides a content sharing platform combined with e-commerce capabilities (hereinafter referred to as the “platform”) to users A, X and Y while communicating with a plurality of user terminals 10, 20 and 30.

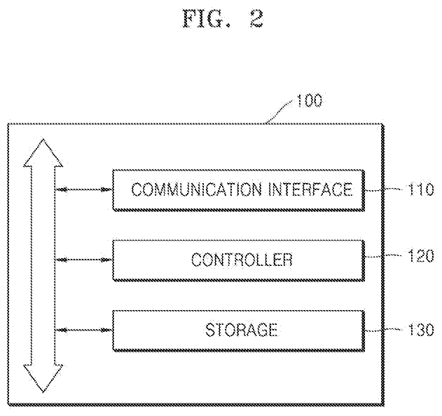

The server 100 may be a computing apparatus having storage and computation functions. Specific components included in the server 100 will be described in detail below with reference to FIG. 2.

Each of the user terminals 10, 20 and 30 is an electronic device having a wired/wireless communication function, and may be, for example, a desktop, a notebook, a smartphone, or a tablet.

In the embodiments described herein, the platform provided by the server 100 may provide a content sharing function to the users A, X and Y of the platform while also providing an e-commerce function for sales of products to the users A, X and Y.

In other words, the users A, X and Y may access the server 100 through their respective terminals 10, 20 and 30, and may then upload content, view content uploaded by other users, and/or purchase products. In this case, the content to be shared is not limited to a specific form, but in this specification, it is assumed that the content is video.

In the embodiment shown in FIG. 1, for ease of description, the users X and Y who upload content and the user A who views content and purchases a product are separated from each other.

Content shared on the platform provided by the server 100 may include content that promotes products sold through the platform. For example, the users X and Y may create video content in such a manner as to shoot a process of unboxing a specific product, to shoot a scene describing a review of the use of a specific product, or to shoot a scene describing various information about a specific product, and may then upload it to the server 100 through the terminals 20 and 30. It is obvious that a method of promoting a product through content is not limited thereto and may be implemented in various manners.

The user A may access the server 100 through the terminal 10 and view content uploaded by the other users X and Y. The user A may acquire information about a specific product by viewing the content and determine whether to purchase the product based on the acquired information.

When a product has been sold, the server 100 may search for content that is determined to have contributed to the sale of the product and distribute a portion of profits from the sale of the product to the right holder of the content. In this case, the “right holder of the content” may mean not only the creator of the content, but may also include a person who has copyright for the content in addition to the creator of the content. For example, when the user X has created content using a video in which an entertainer appears, the entertainer or the agency of the entertainer may be recognized as a copyright holder of the content, although not the creator of the content.

Furthermore, when a product is sold, the server 100 may distribute a portion of profits from the sale of the product to a person having a right to the product in addition to a seller having provided the product to the platform. For example, when goods for an entertainer are sold through the platform, the entertainer and the agency of the entertainer may also be considered to have rights to the goods, and thus the server 100 may distribute portions of profits from the sale of the goods to them.

A specific method by which the server 100 provides content through the platform, sells a product, and distributes profits to people related to the content and the product will be described in detail below with reference to other drawings.

FIG. 2 is a diagram illustrating the configuration of an apparatus for providing a content sharing platform combined with e-commerce capabilities according to an embodiment. The apparatus for providing a content sharing platform combined with e-commerce capabilities, which is shown in FIG. 2, may be the server 100 shown in FIG. 1. Referring to FIG. 2, the 100 includes a communication interface 110, a controller 120, and storage 130.

The communication interface 110 is a component that transmits and receives data to and from the plurality of terminals 10, 20 and 30. To this end, the communication interface 110 may support various wired and wireless communication protocols. For example, the communication interface 110 may be implemented in the form of a communication chipset that supports at least one of communication methods such as Wi-Fi, Bluetooth, and Ethernet.

The controller 120 is a component including at least one processor such as a central processing unit (CPU) , and controls the overall operation of the server 100. The controller 120 may manage the platform by executing a program stored in the storage 130 to be described later and provide a content sharing function and a product sales function to the users through the platform.

The storage 130 may store various types of programs and data. In particular, the storage 130 may store content uploaded by the users, data (e.g. a product list, a product price, etc.) required for the sales of a product through the platform, a program for managing the platform, and the like.

Furthermore, the storage 130 may store information about correspondence relationships between products sold through the platform and content provided through the platform. The reason for this is that in order to search for content that has contributed to the sale of a product, a correspondence relationship between the product and the content is required. In the platform according to the embodiment described in the present specification, both the sharing of content and the sales of products are performed through a single platform, so that it may be possible to determine the correspondence between products and content and distribute profits from product sales accordingly.

When specific content includes content promoting a specific product, the content and the product may be considered to correspond to each other. Accordingly, there may be content corresponding to each product. The storage unit 130 may store information about such correspondence. Information about correspondence may be collected in various manners. For example, a user who uploads content may designate a product corresponding to the content.

Alternatively, a product corresponding to content may be searched for in such a manner that the controller 120 identifies a product appearing in content by performing object recognition through image analysis and then associates it with the content, or analyzes text (e.g., a content title, content information, etc.) stored when content is uploaded.

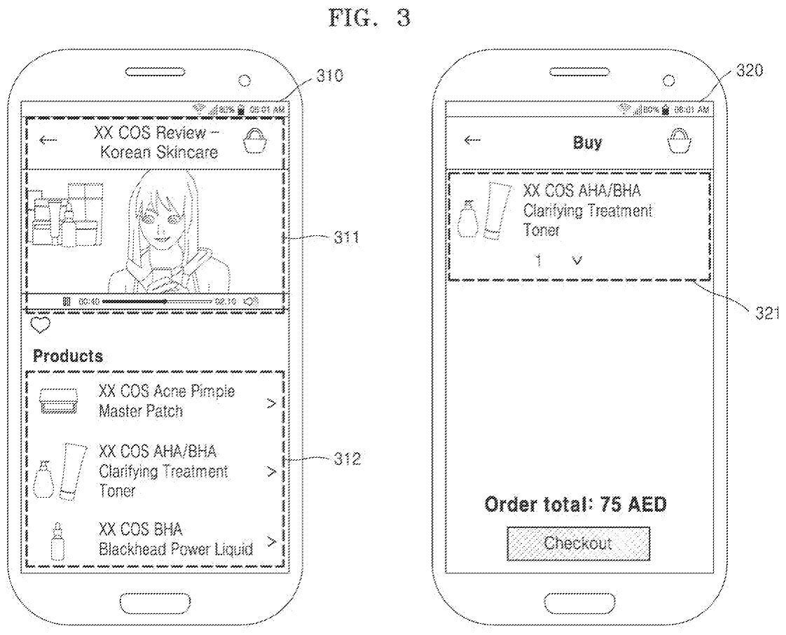

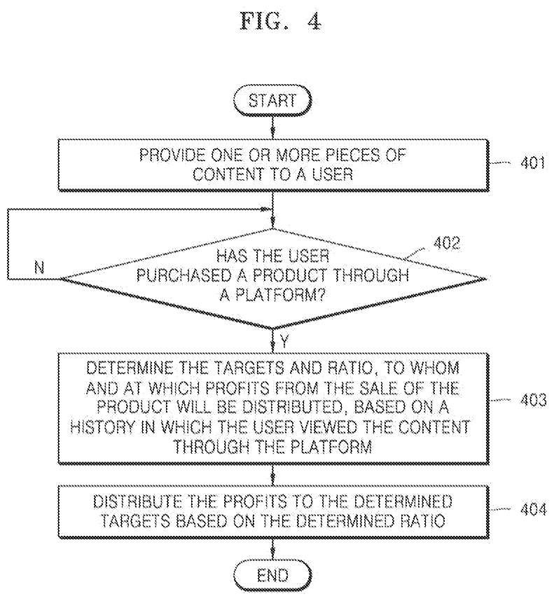

An example in which the server 100 provides a content sharing function and a product sales function to a user through a platform will be described with reference to the user interface (UI) screens shown in FIG. 3. Next, a specific method by which the server 100 searches for content which has contributed to a product sale and determines the targets and ratio to whom and at which profits from the product sale will be distributed will be described with reference to FIGS. 4 to 6.

FIG. 3 is a diagram showing UI screens that are provided to a user through a content sharing platform combined with e-commerce capabilities according to an embodiment. In other words, in the embodiment shown in FIG. 1, when the user A accesses the server 100 through his or her terminal 10, the UI screens shown in FIG. 3 may be displayed on the terminal 10.

First, the user A may view content through the first screen 310. Referring to FIG. 3, video content is played in area 311 of a first screen 310, and a list of products promoted through the content being played in the area 311 is displayed in area 312 of the first screen 310. Accordingly, the user A may view the content and check the products promoted through content at the same time, and may directly access a page for purchase when he or she wants to make a purchase.

When the user A selects any one of the products displayed in the area 312 while viewing the content played in the area 311, a current screen is switched to a page for the purchase of the selected product, as shown in the second screen 320. The user A may check information about the product to be purchased through area 321 of the second screen 320, set a purchase quantity, and then perform payment.

Methods of managing a platform using the above-described server 100 will be described below. FIGS. 4 to 6 are flowcharts illustrating methods of managing a content sharing platform combined with e-commerce capabilities according to embodiments. The methods of managing a platform according to the embodiments shown in FIGS. 4 to 6 include steps that are processed in a time-series manner by the server 100 shown in FIGS. 1 and 2. Accordingly, the descriptions that will be omitted below but have been given above in conjunction with the server 100 shown in FIGS. 1 and 2 may be also applied to the methods of managing a platform according to the embodiments shown in FIGS. 4 to 6.

Referring to FIG. 4, at step 401, the server 100 provides at least one piece of content to a user through the platform. For example, the server 100 may display a list of content, retrieved in response to the user's search request, on the user's terminal, and may provide selected content through the user's terminal when the user selects any one piece of content from the content displayed on the list. Alternatively, the server 100 may select recommended content based on a history of previous content use of the user and display a list of recommended content on the user's terminal. At step 402, the server 100 determines whether or not the user has purchased a product through the platform. In other words, the server 100 proceeds to step 403 only when an event in which the user has purchased a product through the platform occurs.

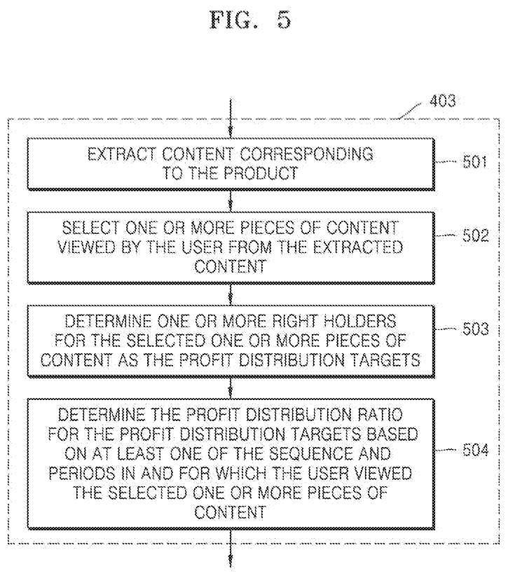

At step 403, the server 100 may determine the targets and ratio, to whom and at which profits from product sales will be distributed, based on a history in which the user who has purchased the product viewed the content through the platform. Step 403 will be described in detail with reference to FIG. 5. FIG. 5 is a flowchart showing detailed steps included in step 403 of FIG. 4. Referring to FIG. 5, at step 501, the server 100 extracts content corresponding to the product purchased by the user. As described above, since information about the correspondence between products and content is stored in the storage 130, the controller 120 may access the storage 130 and extract content corresponding to the sold product when the product has been sold.

At step 502, the server 100 selects at least one piece of content, viewed by the user, from the extracted content. The reason for this is that it may be considered that the content, which belongs to the content corresponding to the product and was viewed by the user who purchased the product, has contributed to the sale of the product. The server 100 may select the content, which corresponds to the product and was viewed by the user who has purchased the product, as contributing content for the sale of the product.

At step 503, the server 100 determines one or more right holders for the content, selected as the contributing content, as one or more profit distribution targets. In this case, the “profit distribution targets” refer to targets to whom portions of profits from the sale of a product will be distributed. As described above, the “right holders for content” include the creator of the content, and may additionally include a person who holds a copyright for the content, although not the creator of the content.

At step 504, the server 100 determines a profit distribution ratio for the profit distribution targets based on at least one of the sequence and periods in and for which the user viewed the contribution content. In detail, the server 100 may calculate purchase contribution levels for the respective pieces of contributing content selected at step 502 and determine a profit distribution ratio based on the purchase contribution levels. According to an embodiment, each of the purchase contribution levels may increase as the period for which a user viewed corresponding content is longer or the sequential position of corresponding content is latter.

A detailed example of a method by which the server 100 determines profit distribution targets and a profit distribution ratio will be described as follows. First, it is assumed that a product P1 is registered in the platform provided by the server 100, three pieces of content C1, C2 and C3 correspond to the product P1, and a user purchases the product P1 after viewing the two pieces of content C1 and C2. When the user purchases the product P1 through the platform, the server 100 extracts the three pieces of content C1, C2 and C3 as content corresponding to the sold product. Thereafter, the server 100 selects the two pieces of content C1 and C2 viewed by the user from among the extracted three pieces of content C1, C2 and C3 as contributing content, and determines right holders for the two pieces of content C1 and C2 as profit distribution targets.

The server 100 calculates purchase contribution levels for the respective pieces of content C1 and P2. The purchase contribution levels may be calculated based on at least one of the sequence and periods in and for which the user viewed the two pieces of content C1 and C2. A method by which the server 100 calculates the purchase contribution levels based on at least one of the sequence and periods in and for which the user viewed the two pieces of content C1 and C2 may be implemented in various manners. Some embodiments of the method will be described below.

In the determination of the purchase contribution level of content, it may be considered that the longer the period for which the content was viewed was, the more the content contributed, and it may also be considered that the latter the sequential position of the content which was viewed by a user was, the more the content contributed. Accordingly, the server 100 may calculate the purchase contribution levels for respective pieces of content in such a manner that a higher M weight is assigned to the content that was viewed in a latter sequential position and a higher weight is assigned to the content that was viewed for a longer period. For example, when a user viewed content C1, then viewed content C2 and finally purchased product P1, the server 100 may assign a higher weight to the content C2 than the content C1. In addition, when the period for which the user viewed content C1 is longer than the period for which the user viewed content C2, the server 100 may assign a higher weight to content C1 than content C2. The server 100 may calculate the purchase contribution levels by taking into consideration both or one of the sequence and the periods in and for which pieces of content were viewed.

Meanwhile, since the content that a user views immediately before purchasing a product is likely to have the greatest influence on the user's purchasing decision, the server 100 may assign the highest weight to the content last viewed by the user before the purchase of the product.

The server 100 determines the profit distribution ratio for the respective profit distribution targets based on the purchase contribution levels of the pieces of content C1 and C2. The higher the purchase contribution level of content, the larger the profit distribution proportion of a right holder (a profit distribution target) for the content.

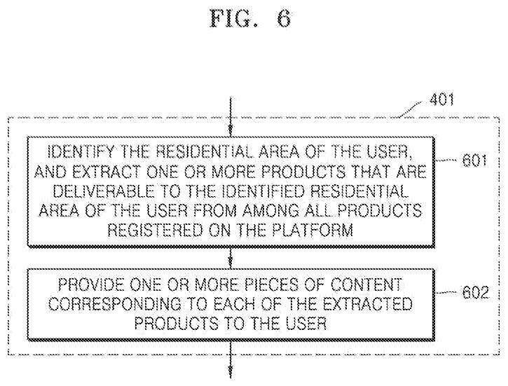

Returning to FIG. 4 again, at step 404, the server 100 distributes profits to the determined targets according to the ratio determined at step 403. In this case, the server 100 may distribute profits from the sale of the product to a product provider, a platform operator, the profit distribution targets, and a person having a copyright for the product. Meanwhile, at step 401 of providing content to the user, the server 100 may provide only content that promotes products that can be delivered to the user. This will be described with reference to FIG. 6.

FIG. 6 is a diagram showing detailed steps included in step 401 of FIG. 4. Referring to step 601, the server 100 identifies the residential area of the user and extracts products that are deliverable to the identified residential area of the user from among all products registered on the platform.

At step 602, the server 100 provides one or more pieces of content corresponding to each of the extracted products to the user.

When a user views content and attempts to purchase a product promoted through the content but the purchase cannot be made because delivery is impossible, the user may feel dissatisfied. In order to overcome this problem, the server 100 may provide only content that promotes deliverable products to the user.

According to the above-described embodiments, the server 100 performs both the provision of content and the sales of products through a single platform, so that it may be possible to easily identify the content that has contributed to the sale of a product and the creator of the content. Therefore, the targets and ratio to whom and at which profits from the sale of the product will be distributed are determined based on a history in which the content was viewed by a user who has purchased the product, and thus the effect of enabling rapid and reasonable profit distribution may be expected.

The term “unit” used in the above-described embodiments means software or a hardware component such as a field-programmable gate array (FPGA) or application specific circuit (ASIC), and a “unit” performs a specific role. However, a“unit” is not limited to software or hardware. A “unit” may be configured to be present in an addressable storage medium, and also may be configured to run one or more processors. Accordingly, as an example, a “unit” includes components, such as software components, object-oriented software components, class components and task components, processes, functions, attributes, procedures, subroutines, segments in program code, drivers, firmware, microcode, circuits, data, a database, data structures, tables, arrays, and variables.

Each of the functions provided in components and “unit(s)” may be coupled to a smaller number of components and “unit(s)” or divided into a larger number of components and “unit(s).”

In addition, components and “unit(s)” may be implemented to run one or more CPUs in a device or secure multimedia card.

Each of the methods of managing a content sharing platform combined with e-commerce capabilities according to the embodiments described with reference to FIGS. 4 to 6 may be implemented in the form of a computer-readable medium that stores instructions and data that can be executed by a computer. In this case, the instructions and the data may be stored in the form of program code, and may generate a predetermined program module and perform a predetermined operation when executed by a processor. Furthermore, the computer-readable medium may be any type of available medium that can be accessed by a computer, and may include volatile, non-volatile, separable and non-separable media. Furthermore, the computer-readable medium may be a computer storage medium.

The computer storage medium may include all volatile, non-volatile, separable and non-separable media that store information, such as computer-readable instructions, a data structure, a program module, or other data, and that are implemented using any method or technology. For example, the computer storage medium may be a magnetic storage medium such as an HDD, an SSD, or the like, an optical storage medium such as a CD, a DVD, a Blu-ray disk or the like, or memory included in a server that can be accessed over a network.

Furthermore, each of the methods of managing a content sharing platform combined with e-commerce capabilities according to the embodiments described with reference to FIGS. 4 to 6 may be implemented as a computer program (or a computer program product) including computer-executable instructions. The computer program includes programmable machine instructions that are processed by a processor, and may be implemented as a high-level programming language, an object-oriented programming language, an assembly language, a machine language, or the like. Furthermore, the computer program may be stored in a tangible computer-readable storage medium (for example, memory, a hard disk, a magnetic/optical medium, a solid-state drive (SSD), or the like).

Accordingly, each of the methods of managing a content sharing platform combined with e-commerce capabilities according to the embodiments described with reference to FIGS. 4 to 6 may be implemented in such a manner that the above-described computer program is executed by a computing apparatus. The computing apparatus may include at least some of a processor, memory, a storage device, a high-speed interface connected to memory and a high-speed expansion port, and a low-speed interface connected to a low-speed bus and a storage device. These individual components are connected using various buses, and may mounted on a common motherboard or using another appropriate method.

In this case, the processor may process instructions within a computing apparatus. An example of the instructions is instructions which are stored in memory or a storage device in order to display graphic information for providing a Graphic User Interface (GUI) onto an external input/output device, such as a display connected to a high-speed interface. As another embodiment, a plurality of processors and/or a plurality of buses may be appropriately used along with a plurality of pieces of memory. Furthermore, the processor may be implemented as a chipset composed of chips including a plurality of independent analog and/or digital processors.

Furthermore, the memory stores information within the computing apparatus. As an example, the memory may include a volatile memory unit or a set of the volatile memory units. As another example, the memory may include a non-volatile memory unit or a set of the non-volatile memory units. Furthermore, the memory may be another type of computer-readable medium, such as a magnetic or optical disk.

In addition, the storage device may provide a large storage space to the computing apparatus. The storage device may be a computer-readable medium, or may be a configuration including such a computer-readable medium. For example, the storage device may also include devices within a storage area network (SAN) or other elements, and may be a floppy disk device, a hard disk device, an optical disk device, a tape device, flash memory, or a similar semiconductor memory device or array.

The above-described embodiments are intended for illustrative purposes. It will be understood that those having ordinary knowledge in the art to which the present invention pertains can easily make modifications and variations without changing the technical spirit and essential features of the present invention. Therefore, the above-described embodiments are illustrative and are not limitative in all aspects. For example, each component described as being in a single form may be practiced in a distributed form. In the same manner, components described as being in a distributed form may be practiced in an integrated form.

The scope of protection pursued via the present specification should be defined by the attached claims, rather than the detailed description. All modifications and variations which can be derived from the meanings, scopes and equivalents of the claims should be construed as falling within the scope of the present invention. According to any one of the embodiments, both the provision of content and the sales of products are performed through a single platform, and thus content having contributed to the sale of a product and the creator of the content may be easily identified. Furthermore, the objects and ration to whom and at which profits from the sale of a product will be distributed are determined based on a history in which a user having purchased the product viewed content, and thus the effect of enabling the rapid and reasonable distribution of profits may be expected.

The effects that can be obtained by the embodiments disclosed herein are not limited to the above-described effects, and other effects that have not been described above will be apparently understood by those having ordinary skill in the art, to which the present invention pertains, from the following description.

What is claimed is:

1. A method of managing a content sharing platform combined with e-commerce capabilities, the method comprising:
providing one or more pieces of content to a user through a content sharing platform;
when the user purchases a product through the content. sharing platform, determining one or more targets and a ratio, to whom and at which profits from a sale of the product will be distributed, based on a history in which the user viewed the content through the content sharing platform; and
distributing the prof to the determined targets based on the determined ratio.

2. The method of claim 1, wherein determining the targets and the ratio comprises:
extracting content corresponding to the product;
selecting one or more pieces of content, viewed by the user, from the extracted content;
determining one or more right holders for the selected one or more pieces of content as the profit distribution targets; and
determining the profit distribution ratio for the profit distribution targets based on at least one of a sequence and periods in and for which the user viewed the selected one or more pieces of content.

3. The method of claim 2, wherein determining the profit distribution ratio for the profit distribution targets comprises:
calculating purchase contribution levels for the respective selected pieces of content; and
determining the profit distribution ratio based on the calculated purchase contribution levels;
wherein each of the purchase contribution levels increases as a period for which the user viewed the corresponding content is longer or a sequential position of the corresponding content which was viewed by the user is latter.

4. The method of claim 2, wherein each of the right holders for the selected one or more pieces of content comprises at least one of a creator of the corresponding content and a copyright holder having a copyright for the corresponding content other than the creator.

5. The method of claim 1, wherein providing the pieces of content to the user comprises:
identifying a residential area of the user, and extracting one or more products that are deliverable to the identified residential area of the user from among all products registered on the content sharing platform; and
providing one or more pieces of content corresponding to each of the extracted products to the user.

6. A non-transitory computer-readable storage medium having stored thereon a computer program that, when executed by a processor, causes the processor to execute the method of claim 1.

7. A computing apparatus for managing a content sharing platform combined with e-commerce capabilities, the computing apparatus comprising:
a communication interface configured to communicate with a terminal of a user who uses a content sharing platform;
storage configured to store information for sales of a plurality of products, content corresponding to each of the plurality of products, and a program for managing the content sharing platform; and
a controller including at least one processor;
wherein the controller executes the program, thereby providing one or more pieces of content to the user through the content sharing platform, and, when the user purchases a product through the content sharing platform, determining one or more targets and a ratio, to whom and at which profits from a sale of the product will be distributed, based on a history in which the user viewed the content through the content sharing platform, and distributing the profits to the determined targets based on the determined ratio.

8. The computing apparatus of claim 7, wherein the controller, when determining the targets and the ratio, extracts content corresponding to the product, selects one or more pieces of content viewed by the user from the extracted content, determines one or more right holders for the selected one or more pieces of content as the profit distribution targets, and determines the profit distribution ratio for the profit distribution targets based on at least one of a sequence and periods in and for which the user viewed the selected one or more pieces of content.

9. The computing apparatus of claim 8, wherein:
the controller, when determining the profit distribution ratio for the profit distribution targets, calculates purchase contribution levels for the respective selected pieces of content, and determines the profit distribution ratio based on the calculated purchase contribution levels; and
each of the purchase contribution levels increases as a corresponding period for which the user viewed the corresponding content is longer or a sequential position of the corresponding content which was viewed by the user is latter.

10. The computing apparatus of claim 8, wherein each of the right holders for the selected one or more pieces of content comprises at least one of a creator of the corresponding content and a copyright holder having a copyright for the corresponding content other than the creator.

11. The computing apparatus of claim 7, wherein the controller, when providing the pieces of content to the user, identifies a residential area of the user, extracts one or more products that are deliverable to the identified residential area of the user from among all products registered on the content sharing platform, and provides one or more pieces of content corresponding to each of the extracted products to the user.
